(19) United States
(12) Patent Application Publication
(10) Pub. No.: US 2014/0211405 A1
(43) Pub. Date: Jul. 31, 2014

(54) SAFETY DETACHABLE ASSEMBLY AND MEMORY MODULE USING THE SAME

(71) Applicant: ADATA TECHNOLOGY CO., LTD., New Taipei City (TW)

(72) Inventor: YU-JEN YANG, TAIPEI CITY (TW)

(73) Assignee: Adata Technology Co., Ltd., New Taipei City (TW)

(21) Appl. No.: 13/863,350

(22) Filed: Apr. 15, 2013

(30) Foreign Application Priority Data
Jan. 30, 2013 (TW) 102202008

(51) Int. Cl. G06F 1/16

(52) U.S. Cl. CPC G06F 1/16
USPC 361/679.32

(57) ABSTRACT

A memory module comprises a PCB and a safety detachable assembly. The PCB has a terminal portion. The safety detachable assembly includes a metal strap connected to the PCB and is disposed on the terminal portion. The metal straps can provide force for the memory module to be detached from a memory slot, and prevent electrostatic from transmitting to the PCB such that normal operations of the PCB maybe affected.

### BACKGROUND OF THE INVENTION

1. Field of the Invention

The instant disclosure relates to a safe detachable design for electronic devices; in particular, to a safety detachable assembly and the memory module using the same which can prevent electrostatic interference.

2. Description of Related Art

As the volume of electronic devices continues to miniaturize, the processing speed and operational functions are gradually becoming faster and more powerful, respectively. As a result, mainboards and electronic components in electronic devices are not only required to be miniaturized, but are also required to provide even higher operation speed in order to meet users' demand. As the data processing power increases, the demand for higher capacity and speed from memory modules of computers increases.

Dynamic random access memory (DRAM) is presented in the form of a module within a computer. In other words, DRAM module includes integrated circuits and printed circuit boards. Users usually first align the printed circuit board of the DRAM module against the memory slot, then apply a force on the top portions of the DRAM module such that the printed circuit board is inserted into the memory slot, thus, the computer system can operate normally.

However, static electricity tends to store in the hands of users and is transmitted to the DRAM module which can lead to abnormal operations thereof. In severe cases, electronic components may malfunction or even be damaged. Moreover, the surface area on top of the DRAM module in which users can apply force upon is relatively small. Specifically, the force applicable area is substantially the thickness of the printed circuit board. As a result, users are more likely to misalign the DRAM module with the memory slot, thus, affecting normal operations, or even worse, damaging the DRAM module.

To address the above issues, the inventor strives via associated experience and research to present the instant disclosure, which can effectively improve the limitation described above.

### SUMMARY OF THE INVENTION

The object of the instant disclosure is to provide a safety detachable assembly to facilitate detachment of electronic devices and prevent static electricity from transmitting to the electronic devices, which may affect normal operations during detachment.

In order to achieve the aforementioned objects according to an embodiment of the instant disclosure, a safety detachable assembly for a memory module of a printed circuit board is provided. The printed circuit board has a terminal portion. Notably, the safety detachable assembly includes a metal strap which is coupled to the portions opposite from the terminal portion of the printed circuit board.

According to the aforementioned safety detachable assembly, the instant disclosure also provides a memory module which includes a printed circuit board and a safety detachable assembly. The printed circuit board has a terminal portion. The safety detachable assembly includes a metal strap which is coupled to the portions opposite from the terminal portion of the printed circuit board.

In an instant embodiment of the instant disclosure, the printed circuit board has a free portion oppositely arranged from the terminal portion. The free portion is formed with a recess, and the metal strap is disposed in the recess.

In an embodiment of the instant disclosure, the printed circuit board is also formed with two thru holes proximate to the recess such that two ends of the metal strap are respectively coupled through the two thru holes in order to be fixed proximate to two portions of free portion 14 that define the recess 141.

In an embodiment of the instant disclosure, the two ends of the metal strap form an annular coupling structure to respectively couple to the two thru holes.

In an embodiment of the instant disclosure, the safety detachable assembly further includes a plurality of metal sleeves. The printed circuit board has a free portion arranged opposite from the terminal portion. The metal sleeves envelop the free portion of the printed circuit board and a portion of the metal strap is coupled between the metal sleeves and the printed circuit board.

In an embodiment of the instant disclosure, the metal sleeves are arranged with a predetermined distance therebetween to provide means for evenly applying force thereon.

In an embodiment of the instant disclosure, the printed circuit board includes a first surface and an oppositely arranged second surface. The first surface and the second surface each has a first corner and a second corner arranged proximate to the terminal portion and have a third corner and a fourth corner arranged away from the terminal portion. The metal sleeves envelop the free portion of the printed circuit board, and the metal sleeves are respectively disposed on the third, fourth corners of the first surface and the third, fourth corners of the second surface.

In an embodiment of the instant disclosure, each of the metal sleeves has a base wall and an annular side wall extended from the base wall. An inner portion of the annular side wall has a protrusion formed thereon. The PCB includes two sidewalls. The sidewalls of the printed circuit board have a plurality of notches formed thereon. The protrusion of the metal sleeve is correspondingly coupled to one of the notches.

In summary, the instant disclosure provides the following features: Through the safe detachable of the instant disclosure, users can single-handedly or two-handedly evenly apply force to detach the memory module from the memory slot via the metal strap of the safety detachable assembly. Moreover, electrostatic is prevented from transmitting to integrated circuits which can cause damages and reduce the usable life of the memory module.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is a schematic diagram of a memory module illustrating the first embodiment according to the instant disclosure;

FIG. 2 is an exploded diagram of the memory module illustrating the first embodiment according to the instant disclosure;

FIG. 3 is a cross-sectional view of the memory module illustrating the second embodiment according to the instant disclosure;

FIG. 4 is a partial detailed view of the memory module illustrating the second embodiment according to the instant disclosure;

FIG. 5 is schematic diagram of the memory module illustrating an operational state of the second embodiment according to the instant disclosure; and

FIG. 6 is an exploded view of the memory module illustrating the third embodiment according to the instant disclosure.

### DETAILED DESCRIPTION OF THE PREFERRED EMBODIMENTS

The aforementioned illustrations and detailed descriptions are exemplarities for the purpose of further explaining the scope of the instant disclosure. Other objectives and advantages related to the instant disclosure will be illustrated in the subsequent descriptions and appended drawings.

### First Embodiment

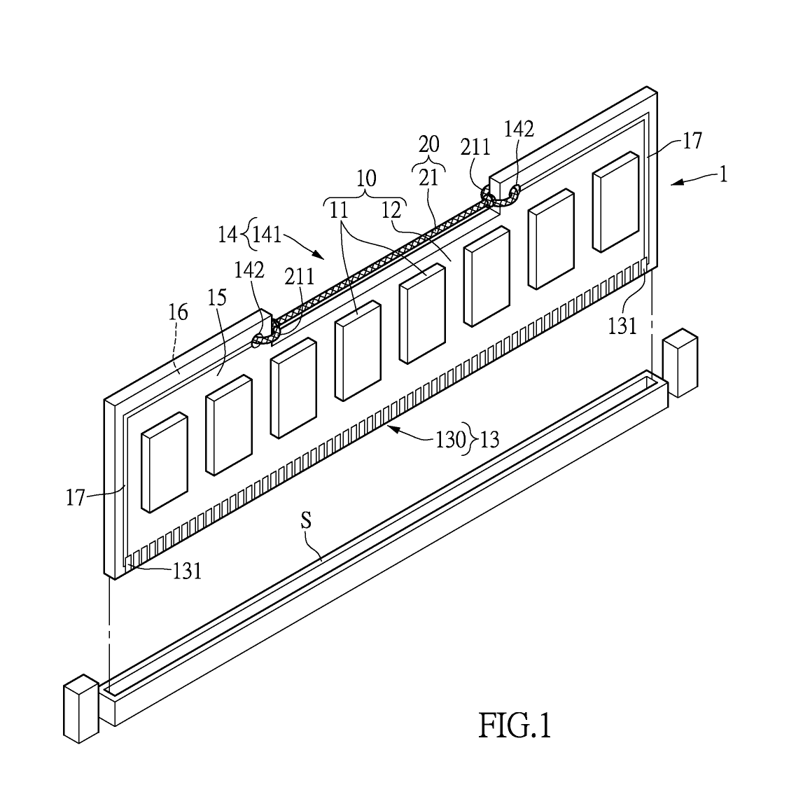

Please refer to FIG. 1 as the schematic diagram illustrating a memory module 1 according to the first embodiment of the instant disclosure. The memory module 1 includes a printed circuit board 10 and a safety detachable assembly 20.

Specifically, the printed circuit board 10 is formed by a plurality of packaged integrated circuits 11 and a module card 12 in which the peripheral portions of the packaged integrated circuits 11 have a plurality of metal pins disposed thereon. A surface of the module card 12 is pattern to form thru holes thereon (not shown in figures) for soldering the metal pins thereto. In addition, the printed circuit board 10 further includes a terminal portion 13 and a free portion 14 arranged away from the terminal portion 13. The terminal portion 13 has a metal contact region 130 defined thereon for inserting into a memory slot S of a computer motherboard, thus, the memory module 1 can store programs and data into the computer system.

The safety detachable assembly 20 includes a metal strap 21 coupled to the free portion 14 of the printed circuit board 10. In the instant embodiment, the free portion 14 of the printed circuit board 10 is formed with a recess 141 where the metal strap 21 can be disposed therein. The length of the recess 141 (defined by the distance between the two opposing sidewalls of the recess) must be larger than the length of the metal strap 21 while both lengths can be adjusted based on the product specifications. Moreover, the placement of the recess 141 is not limited to the example provided herein. However, the preferred placement is located at the center of the free portion to facilitate users to evenly exert force on the printed circuit board 10 via the metal strap 21.

Furthermore, the printed circuit board 10 may also have a plurality of thru holes 142 formed on the first surface 15 and the second surface 16 of the printed circuit board 10. In the instant embodiment, the quantity of thru holes 142 is set as two. (The two thru holes 142 are formed proximate to the edges of the recess 141 respectively.) The two ends of the metal strap 21 are respectively coupled through the two thru holes 142 in order to be fixed to two portions of free portion 14 that define the recess 141. Also, a plurality of metal traces 17 of the first and second surfaces 15, 16 of the printed circuit board 10 are electrically connected to a plurality of ground terminals 131 of the metal contact region 130.

In the instant embodiment, the two ends of the metal strap 21 each respectively extends away from the center to form an annular coupling structure 211. The two coupling structures 211 of the metal strap 21 respectively couple through the two thru holes 142 in order to be fixed proximate to an edge of the recess 141. Users can single-handedly or two-handedly while evenly apply force to detach the memory module 1 from the memory slot S via the safety detachable assembly 20 of the instant disclosure. Moreover, electrostatic stored in users' hand can be transmitted from the metal strap 21 through the ground terminal 131 and further transmitted out of the computer system. As a result, electrostatic is prevented from transmitting to integrated circuits 11, which can cause damages and reduce the usable life of the memory module 1.

### Second Embodiment

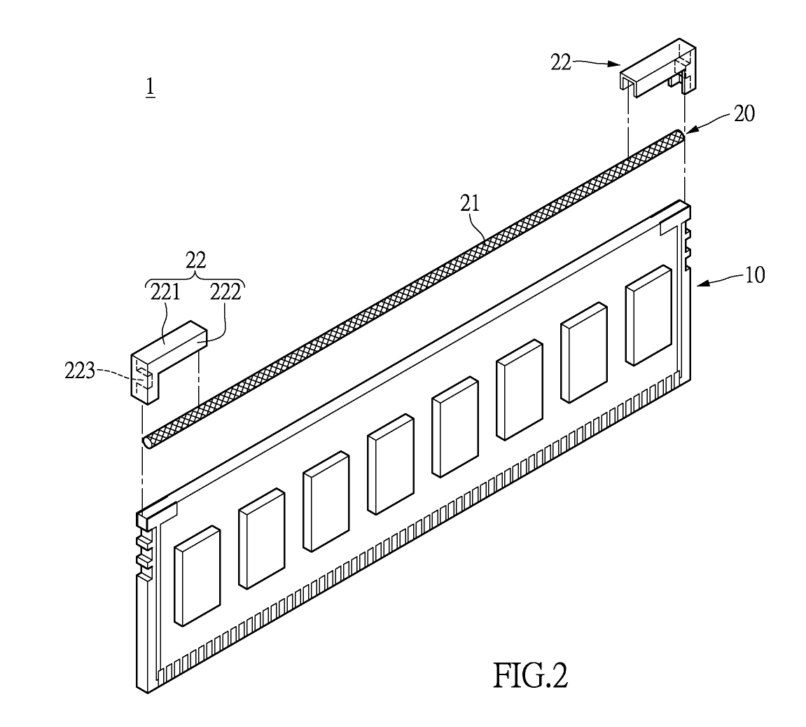

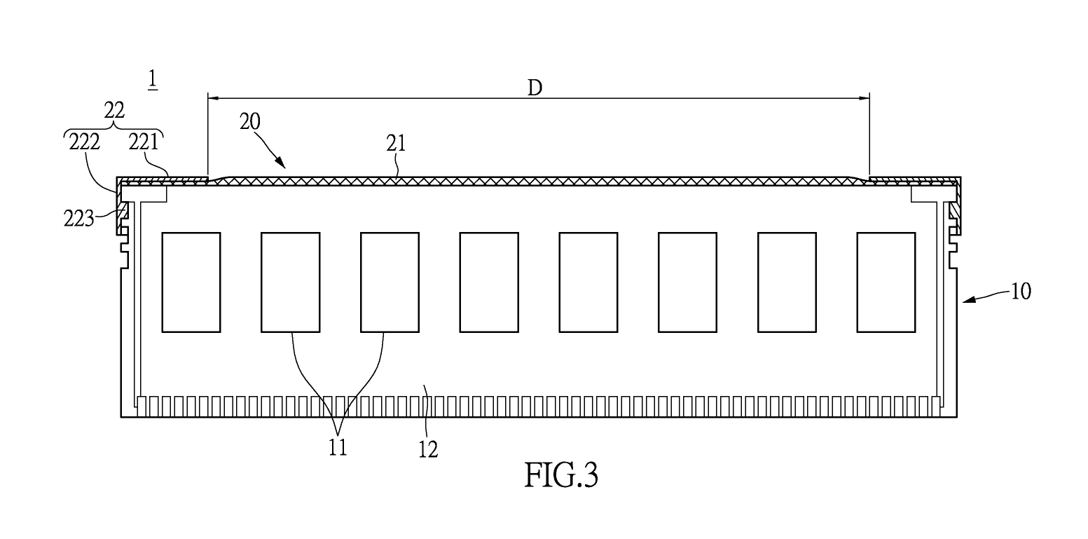

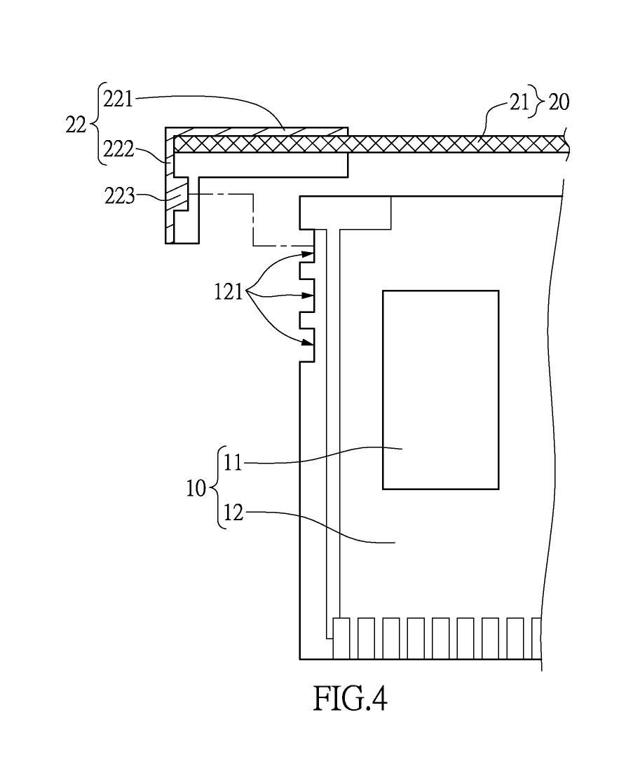

Please refer to FIGS. 2, 3, and 4 to illustrate the memory module according to the second embodiment of the instant disclosure. The second embodiment differs from the first embodiment in that the safety detachable assembly 20 further includes a plurality of metal sleeves 22.

In the instant embodiment, the quantity of the metal sleeves 22 is set as two. The two metal sleeves 22 are disposed on the free portions 14 of the printed circuit board 10 such that a portion of the metal strap 21 is coupled between the metal sleeves 22 and the printed circuit board 10. Moreover, the two metal sleeves 22 are arranged with a predetermined distance D therebetween to provide means for evenly applying force thereon. The predetermined distance D is not particularly limited, as long as the distance allows the metal strap 21 to be fixed and facilitates users' to exert force on the metal strap 21, then the distance is the predetermined distance D between the two metal sleeves 22 of the instant embodiment. The quantity and dimensions of the metal sleeves 22 are not particularly limited to the examples provided herein, and can be adjusted based on the specification's or user's requirement

Moreover, the metal sleeve 22 substantially resembles “L”. Furthermore, the metal sleeves 22 has a base wall 211 and an annular side wall 222 extended from the base wall 211. An inner portion of the annular side wall 222 has a protrusion 223 arranged thereon. The PCB includes two sidewalls. The sidewalls of module card 12 on the printed circuit board 10 have a plurality of notches 121 formed thereon such that the protrusion 223 of the metal sleeve 22 can be selectively coupled to one of the notches 121 depending on the various sizes of the metal strap 21. As a result, the two ends of the metal strap 21 is disposed and fixed on the printed circuit board 10 during the installation of the metal strap 21.

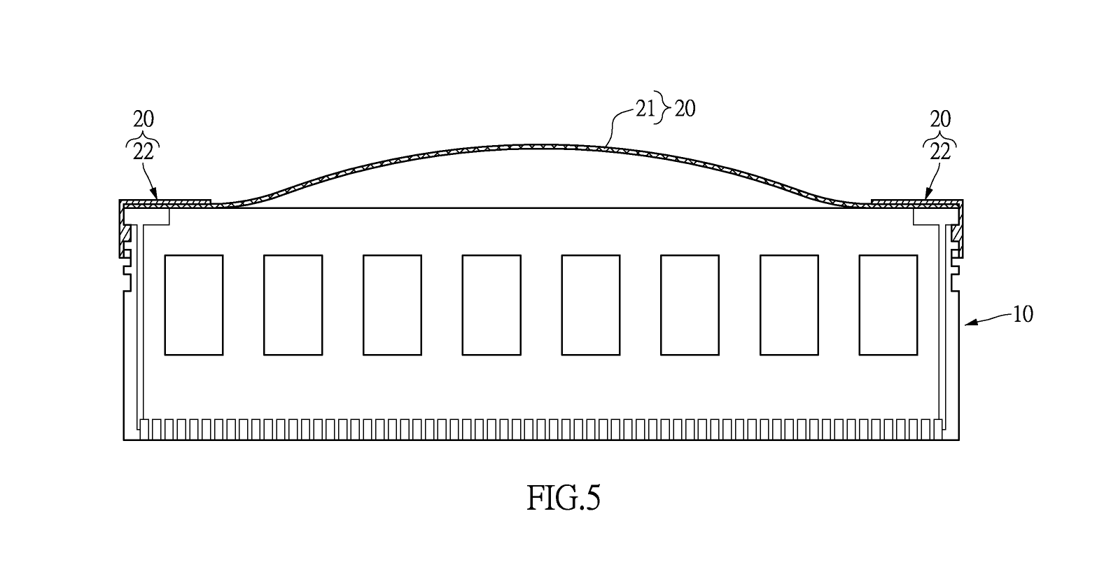

Notably, the metal sleeves 22 of the instant embodiment can be integrally formed with a conductive (such as metals) or non-conductive material (such as plastics). Users may evenly exert force onto the two metal sleeves 22 of the safety detachable assembly 20 according to the instant embodiment such that the memory module 1 is inserted into the memory slot S during the installation of the memory module 1. On the other hand, during the detachment of the memory module 1, users may single-handedly or two-handedly while evenly apply force to detach the memory module 1 from the memory slot S via the metal strap 21 of the safety detachable assembly 20 according to the instant embodiment (as shown in FIG. 5). Moreover, electrostatic stored in users' hand can be transmitted from the metal strap 21 through the ground terminal 131 during installation or detachment to obviate electrostatic interference.

### Third Embodiment

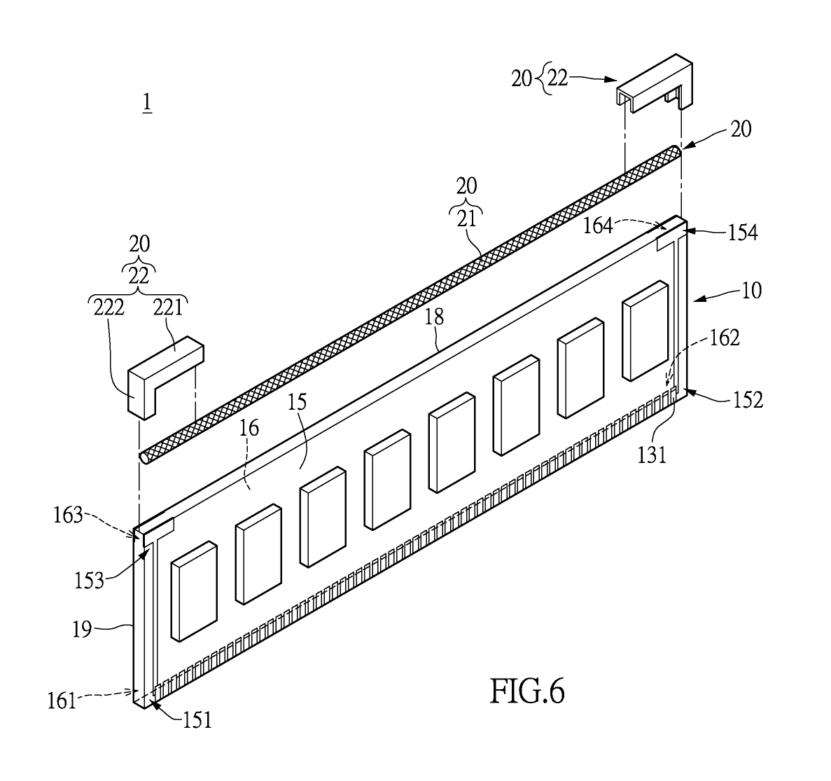

Please refer to FIG. 6 as the schematic diagram of the memory module illustrating the third embodiment according to the instant disclosure. The third embodiment differs from the second embodiment in that no additional coupling structures are required between the printed circuit board 10 and the safety detachable assembly 20 of the instant embodiment.

In particular, the annular side wall 222 of the metal sleeve 22 has two opposing sidewall surfaces which are arranged with a predetermined distance therebetween. The predetermined distance is substantially smaller than the thickness of the printed circuit board 10. The predetermined distance provides the metal sleeves a direct and fit coupling with the free portion 14 of the printed circuit board 10 while no additional coupling structures are required. As a result, a portion of the metal strap 21 is coupled between the metal sleeves 22 and the printed circuit board 10.

Preferably, the first and second surface 15, 16 each respectively has a first corner 151, 161 and a second corner 152, 162 arranged proximate to the terminal portion 13, and a third corner 153, 163 and a fourth corner 154, 164 arranged away from the terminal portion 13. The two metal sleeves 22 directly envelop the free portion 14 of the printed circuit board 10. Specifically, the two metal sleeves 22 each respectively envelops the third corners 153, 163 of the first surface 15 and second surface 16, the fourth corners 154, 164 of the first surface 15 and second surface 16 with a fit coupling. In further details, the aforementioned corners are provided with further explanation. The printed circuit board 10 also has two long sides 18 and two relatively short sides 19, in which each long side 18 intersects with two relatively short sides 19, and vice versa. The first corners 151, 161, second corners 152, 162, third corners 153, 163, and the fourth corners 154, 164 are respectively arranged on four intersections of two long sides 18 and two relatively short sides 19.

In summary, users can single-handedly or two-handedly while evenly apply force to detach the memory module 1 from the memory slot S via the safety detachable assembly 20 of the instant disclosure. Moreover, electrostatic stored in users' hand can be transmitted from the metal strap 21 through the ground terminal 131 and further transmitted out of the computer system. As a result, electrostatic is prevented from transmitting to integrated circuits 11, which can cause damages and reduce the usable life of the memory module 1.

Furthermore, during the installation of the memory module 1, users can evenly exert force with two hands to assure the installation of the memory module 1 into the memory slot S of the computer motherboard. Also, reliability of the electrical connection can be assured between the memory module 1 and the computer system such that the computer system can operate normally.

The figures and descriptions supra set forth illustrated the preferred embodiments of the instant disclosure; however, the characteristics of the instant disclosure are by no means restricted thereto. All changes, alternations, combinations or modifications conveniently considered by those skilled in the art are deemed to be encompassed within the scope of the instant disclosure delineated by the following claims.

What is claimed is:

1. A safety detachable assembly for a memory module of a printed circuit board having a terminal portion, comprising:
a metal strap arranged opposite from the terminal portion and coupled to the printed circuit board.

2. The safety detachable assembly as recited in claim 1, wherein the printed circuit board has a free portion opposite from the terminal portion, the free portion is formed with a recess, and the metal strap is disposed in the recess.

3. The safety detachable assembly as recited in claim 2, wherein the printed circuit board is further formed with two thru holes proximate to an edge of the recess and two ends of the metal strap are respectively coupled through the two thru holes.

4. The safety detachable assembly as recited in claim 3, wherein the two ends of the metal strap extend outwardly and form an annular coupling structure to respectively couple through the two thru holes and fixed proximate to the edge of the recess.

5. The detachable assemblies as recited in claim 1, further comprising:
a plurality of metal sleeves, wherein the printed circuit board has a free portion opposite from the terminal portion, the metal sleeves envelop the free portion of the printed circuit board, and portions of the metal strap are coupled between the metal sleeves and the printed circuit board.

6. The safety detachable assembly as recited in claim 5, wherein the metal sleeves are arranged with a predetermined distance therebetween for evenly applying force thereon.

7. The safety detachable assembly as recited in claim 6, wherein the printed circuit board includes two sidewalls, a first surface and an oppositely arranged second surface, the first surface and the second surface each has a first corner and a second corner proximate to the terminal portion and has a third corner and a fourth corner away from the terminal portion, the metal sleeves envelop the free portion of the printed circuit board, and the metal sleeves are respectively disposed on the third, fourth corners of the first surface and the third, fourth corners of the second surface.

8. The safety detachable assembly as recited in claim 7, wherein each of the metal sleeves has a base wall and an annular side wall extended from the base wall, an inner portion of the annular side wall has a protrusion formed thereon, the sidewalls of the printed circuit board have a plurality of notches formed thereon, and the protrusion of the metal sleeve is correspondingly coupled to one of the notches.

9. A memory module, comprising:
a printed circuit board including a terminal portion; and
a safety detachable assembly including a metal strap, arranged opposite from the terminal portion, and coupled to the printed circuit board.

10. The memory module as recited in claim 9, wherein the printed circuit board has a free portion opposite from the terminal portion, the free portion is formed with a recess, and the metal strap is disposed in the recess.

11. The memory module as recited in claim 10, wherein the printed circuit board is further formed with two thru holes proximate to an edge of the recess and two ends of the metal strap are respectively coupled through the two thru holes.

12. The memory module as recited in claim 11, wherein the two ends of the metal strap extend outwardly and form an annular coupling structure to respectively couple through the two thru holes and fixed proximate to the edge of the recess.

13. The memory module as recited in claim 9, further comprising:
a plurality of metal sleeves, wherein the printed circuit board has a free portion opposite from the terminal portion, the metal sleeves envelope the free portion of the printed circuit board, and portions of the metal strap are coupled between the metal sleeves and the printed circuit board.

14. The memory module as recited in claim 13, wherein the metal sleeves are arranged with a predetermined distance therebetween to provide means for evenly applying force thereon.

15. The memory module as recited in claim 14, wherein the printed circuit board includes two sidewalls, a first surface and an oppositely arranged second surface, the first surface and the second surface each has a first corner and a second corner arranged proximate to the terminal portion and have a third corner and a fourth corner arranged away from the terminal portion, the metal sleeves envelop the free portion of the printed circuit board, and the metal sleeves are respectively disposed on the third, fourth corners of the first surface and the third, fourth corners of the second surface.

16. The memory module as recited in claim 15, wherein each of the metal sleeves has a base wall and an annular side wall extended from the base wall, an inner portion of the annular side wall has a protrusion formed thereon, the sidewalls of the printed circuit board have a plurality of notches formed thereon, and the protrusion of the metal sleeve is correspondingly coupled to one of the notches.
